(19) United States
(12) Patent Application Publication
(10) Pub. No.: US 2010/0245101 A1
(43) Pub. Date: Sep. 30, 2010

(54) COMMUNICATING DEVICE AND COMMUNICATING METHOD

(75) Inventors: WANG-CHANG DUAN, Shenzhen City (CN); BANG-SHENG ZUO, Shenzhen City (CN)

Correspondence Address: WEI TE CHUNG;FOXCONN INTERNATIONAL, INC., 1650 MEMOREX DRIVE, SANTA CLARA, CA, 95050, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/610,377

(22) Filed: Nov. 2, 2009

(30) Foreign Application Priority Data
Mar. 24, 2009 (CN) 200910301087.5

(51) Int. Cl. G08B 21/00

(52) U.S. Cl. 340/636.1

(57) ABSTRACT

A communicating device includes a power source, a storing unit, a detecting unit, and a communicating unit. The power source is operable to supply power to the communicating device. The storing unit is operable to store a warning message for warning that the communicating device is low on power and will be powered off. The detecting unit is operable to measure the remaining power of the power source and determine if the remaining power of the power source drops below a predetermined threshold value. The communicating unit is operable to send the warning message to a target communicating device which the communicating device is communicating with, when the remaining power of the power source is determined to be below the predetermined threshold value.

### BACKGROUND

1. Technical Field

The present disclosure relates to communicating devices, and particularly to a communicating device and a communicating method capable of sending out a warning message.

2. Description of Related Art

Current communicating devices such as mobile phones, may be abruptly disconnected during a call because the battery goes dead. This may cause the other party to misinterpret that the user hung up impolitely.

Therefore, it is desirable to provide a communicating device and a communicating method which can overcome the above-mentioned problems.

### BRIEF DESCRIPTION OF THE FIGURE

The components of the drawings are not necessarily drawn to scale, the emphasis instead being placed upon clearly illustrating the principles of the embodiment of a communicating device and a communicating method. Moreover, in the drawings, like reference numerals designate corresponding parts throughout several views.

FIG. 1 is a block diagram of a communicating device, according to an exemplary embodiment.

FIGS. 2a and 2b are a flowchart of a communicating method, according to another exemplary embodiment.

### DETAILED DESCRIPTION

Embodiments of the present disclosure will now be described in detail with reference to the drawings.

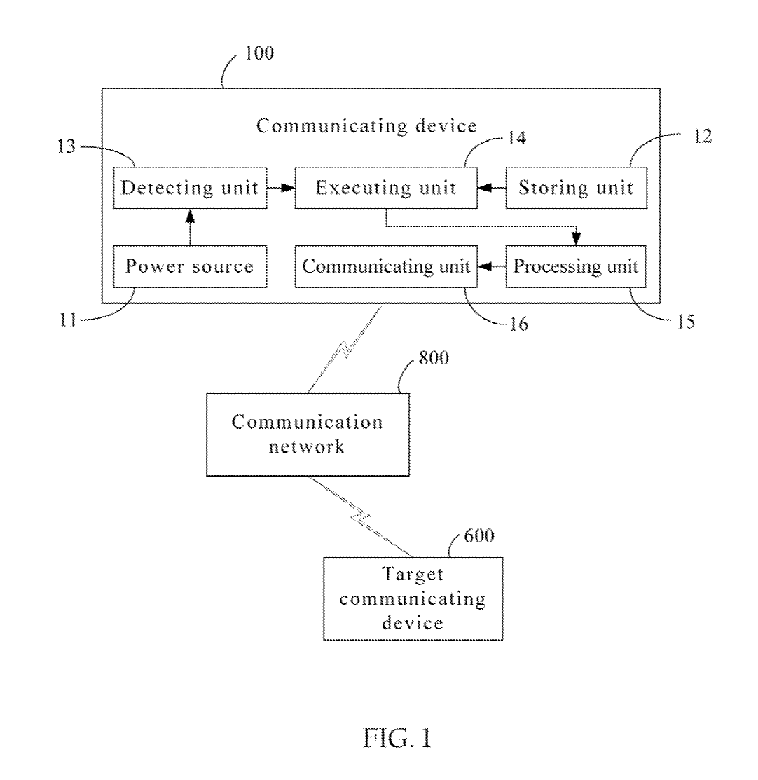

Referring to FIG. 1, a communicating device 100 includes a power source 11, a storing unit 12, a detecting unit 13, an executing unit 14, a processing unit 15, and a communicating unit 16. The communicating device 100 can be a mobile phone, a fixed-line telephone, and so on. In this embodiment, the mobile communicating device 100 is shown as a mobile phone for description.

The power source 11 is operable to supply power to various components of the communicating device 100. In general, the power source 11 includes a battery. A remaining power of the power source 11 gradually decreases when the communicating device 100 is working.

The storing unit 12 is operable to store a predetermined warning message for warning that the communicating device 100 is low on power and will be powered off. The storing unit 12 includes one or more types of memory, such as read only memory (ROM) and random access memory (RAM). The warning message can be a text message or a voice message. In practice, the warning message can be pre-stored during manufacturing. In other embodiments, the warning message may be installed manually by a user of the communication device 100.

The detecting unit 13 is operable to measure the remaining power of the power source 11 and compare the remaining power with a predetermined threshold value recorded in the detecting unit 13. If the remaining power is smaller than the predetermined threshold value, the detecting unit 13 sends an executing signal to the executing unit 14. Then, if the remaining power of the power source 11 further drops below a predetermined critical value that is just below the predetermined threshold value, the communicating device 100 will power off automatically. In practice, the detecting unit 13 may include a number of circuitries, as is known in the art, for measuring the remaining power and generating the executing signal.

The executing unit 14 is operable to read the warning message stored in the storing unit 12 when receiving the executing signal and send the warning message to the processing unit 15.

The processing unit 15 is operable to process the warning message into a baseband signal. In detail, the processing unit 15 may further encode and modulate the baseband signal to a radio frequency signal.

The communicating unit 16 is operable to establish a communication channel with a target communicating device 600. In this embodiment, the communicating unit 16 is wirelessly connected to the target communicating device 600 via a communication network 800. The communicating unit 16 can transmit the radio frequency signal of the warning message to the communication network 800. The target communicating device 600 receives the radio frequency signal from the communication network 800. In practice, the communicating unit 16 may include an antenna, a duplexer, etc.

When the remaining power of the power source 11 drops below the predetermined threshold value, the communicating unit 16 sends the radio frequency signal of the warning message to the target communicating device 600. The target communicating device 600 will output the warning message. As such, the other party on the communication channel using the target communicating device 600 will not misinterpret any sudden abrupt disconnections as an impolite gesture.

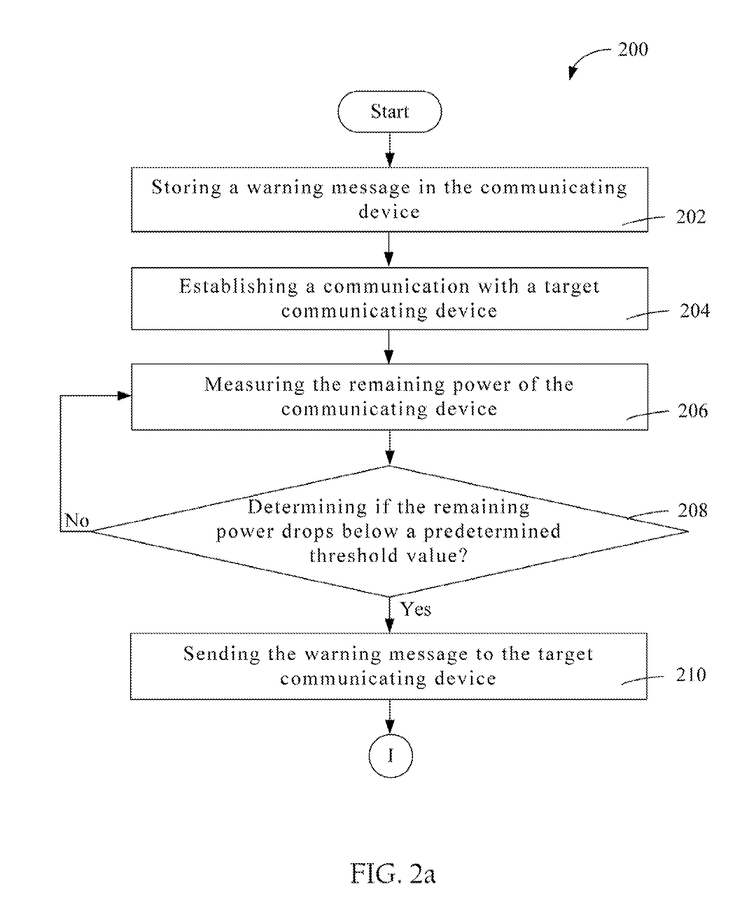

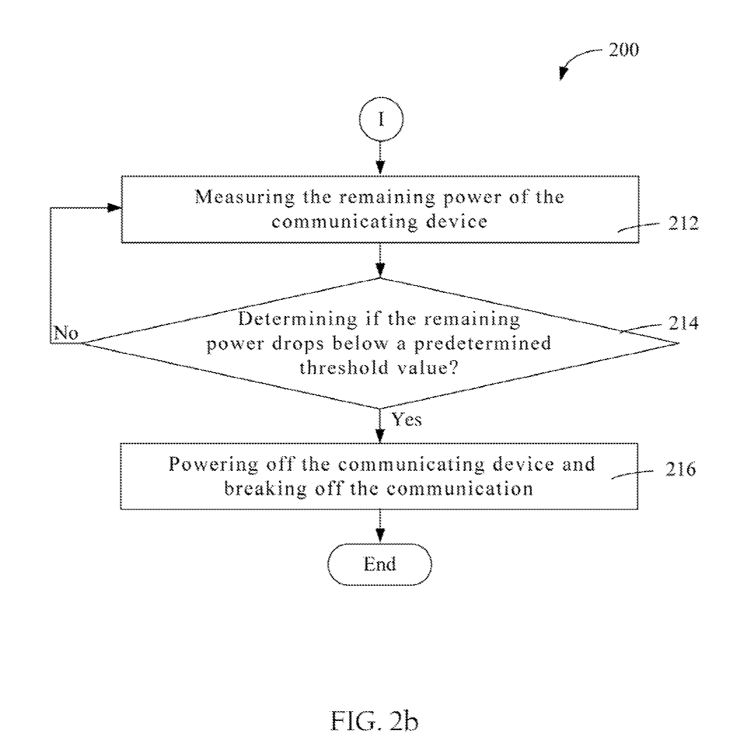

FIGS. 2a and 2b show a flowchart of a communicating method 200, which can be performed by a communicating device. In this embodiment, the communicating method 200 includes steps 202-210.

Step 202: storing a warning message in the communicating device. The warning message is used for warning that the communicating device is low on power and will be powered off. The warning message can be a text message or a voice message.

Step 204, establishing a communication with a target communicating device. In detail, the communication is established between the communicating device and the target communicating device via a communication network.

Step 206: measuring the remaining power of the communicating device during the communication.

Step 208: determining if the remaining power of the communicating device drops below a predetermined threshold value. If yes, the procedure goes to step 210. If not, the procedure goes back to step 206.

Step 210: sending the warning message to the target communicating device. As such, the party of the communication using the target communicating device will not misinterpret any sudden abrupt disconnections as an impolite gesture.

Step 212: continuing to measure the remaining power of the communicating device.

Step 214: determining if the remaining power of the communicating device further drops below a predetermined critical value which is just below the predetermined threshold value. If yes, the procedure goes to step 216. If not, the procedure goes back to step 212.

Step 216: powering off the communicating device automatically and breaking off the communication.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A communicating device, comprising:
a power source operable to supply power to the communicating device;
a storing unit operable to store a warning message for warning that the communicating device is low on power and will be powered off;
a detecting unit operable to measure a remaining power of the power source and determine if the remaining power drops below a predetermined threshold value; and
a communicating unit operable to send the warning message to a target communicating device which the communicating device is communicating with, when the remaining power of the power source is determined to be below the predetermined threshold value.

2. The communicating device of claim 1, wherein the detecting unit is further operable to determine if the remaining power of the power source further drops below a predetermined critical value that is below the predetermined threshold value, the communicating device is powered off automatically when the remaining power of the power source is determined to be below the predetermined critical value.

3. The communicating device of claim 1, further comprising an executing unit, wherein the detecting unit is further operable to generate an executing signal when the remaining power of the power source drops below the predetermined threshold value, the executing unit is operable to read the warning message when receiving the executing signal from the detecting unit.

4. The communicating device of claim 1, wherein the communicating device is a mobile communicating device, the communicating unit is operable to be connected to the target communicating device wirelessly.

5. The communicating device of claim 4, further comprising a processing unit operable to process the warning message into a radio frequency signal, the communicating unit being operable to transmit the radio frequency signal.

6. The communicating device of claim 1, wherein the warning message is a text message or a voice message.

7. The communicating device of claim 1, wherein the warning message is stored in the storing unit during manufacturing.

8. A communicating method capable of being performed by a communicating device, the communicating method comprising:
establishing a communication with a target communicating device;
determining if a remaining power of the communicating device drops below a predetermined threshold value during the established communication; and
sending a warning message to the target communicating device when the remaining power of the communicating device is determined to be below the predetermined threshold value, the warning message being configured for warning that the communicating device is low on power and will be powered off.

9. The communicating method of claim 8, further comprising:
determining if the remaining power of the communicating device further drops below a predetermined critical value that is below the predetermined threshold value; and
powering off the communicating device automatically and breaking off the communication if the remaining power of the communicating device is determined to be below the predetermined critical value.

10. The communicating method of claim 8, further comprising:
storing a warning message in the communicating device.

11. The communicating method of claim 8, wherein the warning message is a text message or a voice message.
